(19) United States
(12) Patent Application Publication
(10) Pub. No.: US 2002/0118860 A1
(43) Pub. Date: Aug. 29, 2002

(54) Document watermarking method using line margin shifting

(76) Inventor: Joe Pasqua, Menlo Park, CA (US)

Correspondence Address: Tyler S. Brown, Morrison & Foerster LLP, 2000 Pennsylvania Ave., N.W., Washington, DC, 20006-1888, US

(21) Appl. No.: 10/080,567

(22) Filed: Feb. 25, 2002

Related U.S. Application Data
(60) Provisional application No. 60/270,595, filed on Feb. 23, 2001.

(51) Int. Cl. G06K 9/00

(52) U.S. Cl. 382/100

(57) ABSTRACT

A method is provided for watermarking a document using line margin shifting. The method shifts the left margin of lines of text either right or left to encode a watermark in a textual document. To embed the watermark, certain lines of the text are selected to carry watermark information. These lines are shifted either right or left to indicate a 1 or 0.

### FIELD OF THE INVENTION

The present invention relates to document watermarking. More particularly, the present invention relates to document watermarking using line margin shifting.

### BACKGROUND OF THE INVENTION

Watermarking deters users from making illicit copies of electronic documents. A traditional approach to this problem is the use of a hidden watermark. Such a watermark can be used to carry an indication of the original recipient of the document so that an illicitly copied version can be traced back to its source.

There are a number of techniques known for watermarking textual documents. U.S. Pat. Nos. 6,086,706 and 5,629,770 describe techniques for adjusting the spacing between lines and between groups of words to encode a watermark. This line spacing technique dictates that at most only every other line of text can be used to carry watermark information. The rest of the lines are used as controls.

Another well-known technique for watermarking textual documents is by substituting words, phrases, entire sentences, or punctuation. That is, pieces of a document are re-written for each recipient of the document. This technique is very difficult to apply automatically with acceptable results since it involves parsing, and to some limited degree, understanding natural languages such as English. This technique is also not well suited to many applications where it is unacceptable to modify the words of the source document in any way.

Other techniques embed a watermark in the electronic version of a document in a way that is not detectable in the visual representation of the document. For example, a watermark may be placed in document metadata fields or encoded in the representation of the document itself. Thus, these other techniques cannot detect the watermark in the hardcopy version of the document, only in the electronic version.

Conventional techniques have these and other drawbacks and disadvantages.

### SUMMARY OF THE INVENTION

The present invention provides a method for overcoming the disadvantages and drawbacks of conventional systems. This invention provides a method for watermarking documents using line margin shifting.

According to one embodiment, a method for detecting a watermark in a document is provided. The method includes loading a first page image of a watermarked document; locating a set of scanlines in the watermarked first page image; calculating a detection value; loading a first page image of an original document; locating a set of scanlines in the original first page image; calculating a target value; and determining a difference between the target value and the detection value.

According to another embodiment, a method for watermarking a document is provided. The method includes determining a watermark value; determining a watermark key; determining a first watermark line based on the watermark key; and shifting a left margin of the first watermark line based on the watermark value.

The watermark according to this invention can be detected in both the electronic version of a document as well as a hardcopy version. This requires a visible change to the document since the hard copy captures just the appearance of the document. The visual change is not be perceptible to a reader of the document. The watermark can be detected in a hardcopy version of the document even if it has been photocopied one or more times and the quality of the resultant pages is degraded.

Still other embodiments of the present invention will become apparent to those skilled in the art from the following detail description, wherein is shown and described only the embodiments of the invention by way of illustration of the best moods contemplated for carrying out the invention. As will be realized, the invention was capable of modification in various obvious aspects, all without departing from the spirit and scope of the present invention. Accordingly, the drawings and details description ought to be regarded as illustrative in nature and not restrictive.

### BRIEF DESCRIPTION OF THE DRAWINGS

FIG. 1 depicts exaggerated and realistic samples of margin shifted lines according to one embodiment of the invention.

FIG. 2 depicts a graph of a typical scanline histogram according to one embodiment of the invention.

FIG. 3 depicts a graph of a typical h(x) or g(x) according to one embodiment of the invention.

FIG. 4 depicts the correlation of h(x) and g(x) according to one embodiment of the invention.

### DETAILED DESCRIPTION OF THE INVENTION

The invention uses shifts in the left margin of lines of text to encode a watermark in a textual document. In particular, a number of lines are identified that will carry the watermark information. Each line of text carries one bit of the watermark. The correspondence between a line of text and a bit position in the watermark is determined using a key. For each bit of the watermark, the corresponding line of text in the document is shifted to the left if the bit is 0 or to the right if the bit is 1. For a watermark consisting of N bits of information, N lines of text must be shifted either left or right. This invention can also use right margin shifting for fully justified margins and shift to the left if the bit is 1 or to the right if the bit is 0.

To read a watermark from a document one reverses the process. The position of lines in the watermarked document are compared to the position of corresponding lines in the original to determine which lines have been shifted and in what directions. Having collected that information, one can reconstruct the watermark data bit by bit.

Since this invention preferably results in shifts to the left margin of lines, it can be used in combination with other techniques that make orthogonal changes. For example, it could be used in combination with a technique that adjusts the vertical spacing between lines such as that described in US Pat. Nos. 6,086,706 and 5,629,770, incorporated herein by reference.

A watermark, W (watermark data), is a sequence of bits that identifies the original recipient of a document. The watermark is embedded into the electronic form of the original, Oₑ, (unwatermarked), to produce a watermarked version, Mₑ (electronic form of the watermarked document). This watermarked version is still in electronic form. Each bit of the watermark is associated with a given line of text in the document. That entire line of text is shifted either to the left or to the right by a small amount (delta) depending on the value of the associated watermark bit. A 0 bit would cause the line to be shifted to the left and 1 bit would cause the line to be shifted to the right.

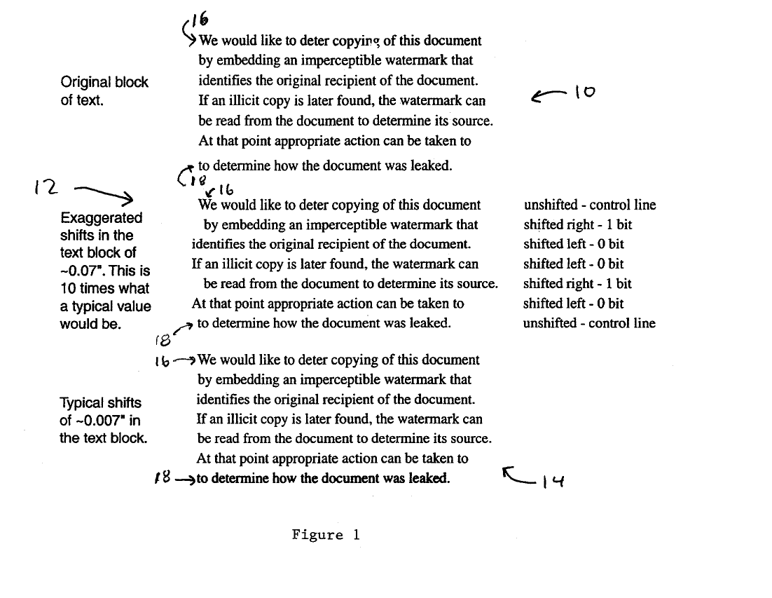

FIG. 1 shows how the process affects a sample piece of text. The same block of text is shown three times. The first version is the original, unshifted, text 10. The second version 12 shows the lines shifted by an exaggerated amount to make it easier to see what is happening. In this case the shift is ˜10 times greater than would be typically used. The last version 14 shows the lines shifted with a more realistic value. Preferably, lines need only be shifted by a delta (amount of left or right shift) of approximately 1/300 or 1/150 of an inch. The amount of delta can be much greater or smaller and is only limited by the sensitivity of the detection process.

FIG. 1 demonstrates how the left margin of each line is shifted independent of the others to carry a bit of information. In this example five bits of information have been encoded. The remaining two lines 16 and 18 have been set aside as controls. Any number of control lines can be used (or a single line) and they can be any line of the text. Preferably, two controls are used and they are the first and last line of the text.

The first 16 and last lines 18 of the text in FIG. 1 were not shifted. They were left as control lines to be used by the detection process to help account for scaling and transformation changes that might occur to the hardcopy during printing, photocopying, and faxing. For example, it is common for the text on a copied page to be slightly larger or smaller than the original. Furthermore, the registration of the page on the copying, fax, or scanning device may not have been perfect causing the margin of the document to be slanted to either the left or right.

An unshifted control line in Mₕ (hardcopy form of the watermarked document) can be compared to its counterpart in Oₕ (hardcopy form of the original, unwatermarked document) to determine how much bigger or smaller the line has become and whether the line has been translated horizontally from the original. Since control lines are unshifted, they carry no watermarking information.

The number of lines to be used as controls and their placement on the page can vary. The embedding software and the detecting software must agree on which lines are controls so that these lines will not mistakenly be included as information-carrying lines. This agreement can be achieved in a number of different ways such as agreeing that the first and last line of each paragraph will be controls or that every nth line will be a control; Alternatively, the embedding software can decide which lines are controls using an arbitrarily complex algorithm and store those selections in a file that will be read by the detector at detection time.

A key is supplied to the watermark embedding code to be used in controlling the correspondence between bits of the watermark and lines in the document. A key is simply a number (our implementation uses a 32 bit number) that is used to create the correspondence in a deterministic way. In one implementation, the key can be used as the seed to a pseudo-random number generator (PRNG). Given a specific seed, a PRNG will always generate the same sequence of output.

The output of the PRNG is a sequence of numbers that can be used to specify a line. For example, the embedding code might invoke the PRNG twice to get two numbers that together specify a line. The first number would specify the page and the second number would specify the line on that page (P, L). The PRNG might generate values in the range of [0 . . . 1], so the results would have to be scaled to the corresponding range; e.g. from 1 to N, where N is the number of pages in the document. A sample sequence from the PRNG (after scaling) might be (2, 12), (5, 1), (6, 23). This sequence indicates that bit 0 of the watermark would be denoted by a left or right shift to line 12 on page 2, bit 1 of the watermark would be carried by line 1 on page 5, and bit 2 of the watermark would be carried by line 23 on page 6.

There are many ways to use a simple numeric key to determine a sequence of lines and there are many schemes for numbering lines. The point is that without the key, there is no easy way to determine which lines in the document carry watermark information and how the bits of the watermark correspond to lines on pages. This provides protection against unauthorized persons reading the watermark since they will not be in possession of the key. It also prevents forging a watermark since the forger will not know the correct key to use for a given document. Note that with careful analysis using a magnifying glass a human might be able to determine which lines have been shifted. This is still not enough information to read the watermark since the observer will not know which shifted line corresponds to which bit of the watermark.

It is up to the user of the watermarking software, or another encompassing piece of software, to supply the keys and to remember which key has been used for each document.

The watermark is embedded in the electronic form of the document. The actual process for shifting the left margin of a line varies based on the file format used to represent the document. For documents in Adobe PostScript or Adobe PDF form, the lines can be shifted in a number of different ways. For example, one might translate the current transformation matrix (CTM) before the line of text is drawn and restore it afterwards. Alternatively, one could modify the location of each individual character in the line by a positive or negative amount.

One embodiment of the invention shifts the lines by approximately 1/150th of an inch (delta=1/150th). Alternatively, the shift can be as small as 1/300th of an inch. Neither is readily perceptible to a human reader.

Embedding redundant information in the document can serve to make the watermarking scheme more resilient to document modifications. Such modifications could be accidental, such as an inkblot on the page, or malicious, such as an attacker intentionally trying to confuse the system.

One way of achieving redundancy is to embed multiple copies of the watermark into the document. Of course, to accomplish this the document must have enough pages and lines to carry the watermark bits multiple times. Embedding another copy of the watermark proceeds in the same fashion as embedding the first copy. A new set of lines is computed based on the key and those lines are shifted in correspondence to the watermark values. There are variations on this method. For example, a different key could be used for each copy of the watermark. In such a case the user would be responsible for remembering not only a single key, but multiple keys.

There are a number of other methods for achieving redundancy in the document other than replicating the watermark bits. For example, information theoretic codes (such as error correcting codes) can be used. This is discussed further below. Because all of these schemes rely on redundant information, they all lower the useful bandwidth of the document. That is, the same number of text lines can carry less information but in a more robust way.

Detecting the watermark in the hardcopy representations of a given document typically involves the following steps. Each step will be described in more detail below.

1) Scan Mₕ to produce a collection of N page images—one per page.

2) Process each page image using traditional image processing software to clean-up excessive noise (e.g. speckling) and gross translation and scaling changes. Depending on the quality of Mₕ, this step may not be necessary.

3) Use the supplied key (the same one used at embedding time) to seed some process for generating a sequence of numbers that will determine which lines carry the watermark information and in what order.

4) Retrieve each bit of the watermark in turn by generating the location of the line that carries the watermark information and then taking the following steps. The location can be considered to consist of a page number, P, and a line number, L.

a) Load the image of page P from Mₕ. It contains the line that corresponds to the current bit of the watermark.

b) Locate the set of scanlines in the image that corresponds to L.

c) Let g(x) be a function whose value is defined to be the count of all of the black pixels in column x of the scanlines just identified.

d) Load the image of page P from Oₕ.

e) Locate the set of scanlines in the image that corresponds to L.

f) Let h(x) be a function whose value is defined to be the count of all of the black pixels in column x of the scanlines just identified.

g) Perform a correlation between g(x) and h(x) to determine whether the line has been shifted to the left or to the right. The result indicates whether the current watermark bit is a 0 or a 1.

5) Repeat this process for each bit of the watermark.

6) If the watermark was embedded multiple times, repeat the entire process to detect other copies of the watermark. Compare each watermark that is read from the document to ensure that they are all consistent. Potentially use other schemes to recover redundant information.

The following descriptions examine each of these steps in more detail. Since many of the steps are performed on both the original document and the watermarked document, those steps will be discussed together.

### Scanning and Cleanup

These steps can be performed using existing scanning and image processing software. The user of the detection software would use such software on each page to produce a set of page images of both Mₕ and Oₕ. Alternatively, scanning and clean-up software could be integrated into the detector itself. The cleanup phase should remove excessive noise (speckling) caused by any copying or faxing that occurred prior to scanning as well as any artifacts produced by scanning itself. Cleanup should also account for any skewing of the page that may have been caused by these same processes. There are a number of techniques known to deskew documents including techniques based on the Hough transform.

### Generating a Sequence of Line Locations

This process mirrors what happens at embedding time. This process generates the same set of lines that was generated at embedding time. This ensures that the watermark will be found and that the bits of the watermark are reconstituted in the correct order. The result of this process is a sequence of line locations that can be considered a collection of tuples of the form (P, L) where P is a page number and L is the number of a line on that page.

### Loading the Page Image

These steps involve locating the scanned image that corresponds to page P and loading it into an image structure for processing.

### Locating Scanlines

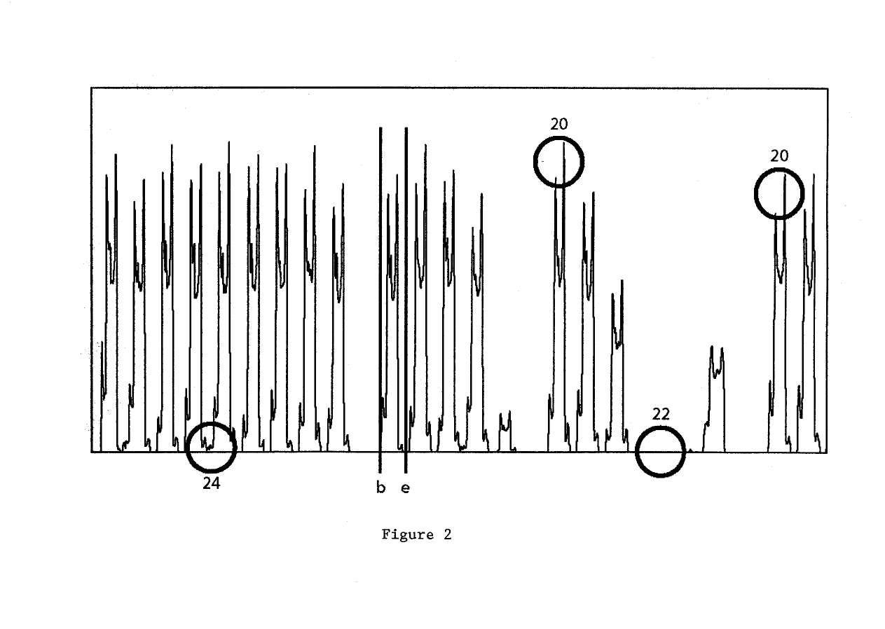

These steps are used to determine which scanlines in the page image correspond to line L. To determine this we compute a function f(y) whose value at a given point y is said to be the count of all black pixels in scanline y. The graph of this function will tend to look like the one given in FIG. 2. Each spike 20 corresponds to a line of text and the gaps 22 between the spikes correspond to the spaces between lines or paragraphs.

Sometimes the gaps will not be zero valued due to characters (see gap 24), like a lower case y, that extend below the base line of a line and other characters, like superscripted copyright symbols, that extend higher than normal on a line. Regardless of this, lines are readily detectable by the change between a high valued spike of values followed by a region of zero or near zero values. By examining the values of f(y) one can readily determine the set of scanlines that constitute a given line. They are the set of scanlines that correspond to the spike. This invention is resilient to minor variations in the exact set of scanlines determined at this step.

The set of scanlines found define a rectangular subimage of the page that begins at scanline b and ends at scanline e. The set of scanlines that correspond to a line of text begins at a gap between spikes and ends at the next gap. The space between lines of text correspond to gaps and the lines of text themselves correspond to spikes.

### Defining the Line Waveform Functions

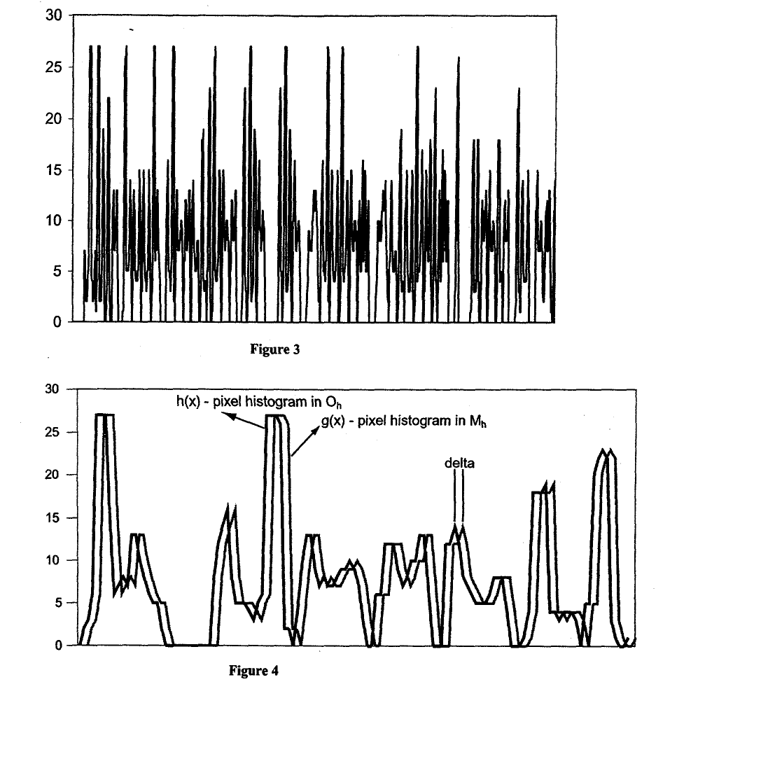

Once we have determined which scanlines correspond to a given line we can compute g(x). The value of g(x) at a given location x is defined to be the count of black pixels in column x of the subimage located previously. The graph of this function will tend to look like the sample given in FIG. 3. In this case each spike corresponds to a character (or multiple touching characters) and the gaps between the spikes correspond to the spaces between characters and words. The spikes and gaps are narrower than those produced by f(y) since the features are correspondingly smaller.

This function, g(x), is defined over the scanlines in Mₕ. We define a corresponding function, h(x), over the scanlines in Oₕ Because the lines in Mₕ are shifted relative to those in Oₕ we expect that either h(x)≈(x+delta) or h(x)≈(x-delta). Of course this will not be an exact equality due to analog noise, but we use this relationship to determine which way the line was shifted. For the control line(s), h(x)=g(x).

Because the page images of Mₕ and Oₕ may still differ somewhat in scaling and translation, we adjust the values of the function g(x) to compensate. We do this by comparing the closest one or two control lines from Mₕ to those from Oₕ. Since the control lines are unshifted, we can use them to determine how much the control line in the marked version has been scaled and translated relative to the control line in the original. We can use the scale and translation information to adjust the value of x fed into g(x). For example, if Mₕ is scaled to be one percent smaller than Oₕ then we would scale the value of x correspondingly so that the value of h(x) would be compared to the value of g(x*0.99). A more involved supersampling or subsampling of g(x) is generally not necessary in order to compensate for small variations in scale between Mₕ and Oₕ. Correlate g(x) and h(x)

To determine whether a given line has been shifted to the left or to the right, we compare the functions g(x) and h(x). As mentioned above, we should find that h(x)≈(x+delta) for either a positive or negative delta. We can perform this correlation in a number of different ways. For example, we could slide h(x) to the left and right by delta and test the difference between it and g(x). The difference should be minimized in the direction that the line was actually shifted.

This invention computes the following sum over all values of x from 0 to the width of the scanlines:

s=Σh(x)(g(x-delta)−g(x+delta))

If s>0 this indicates a left shift, otherwise a right shift is indicated. FIG. 4 shows the graphs of idealized instances of h(x) and g(x). In this example, the margin has been shifted to the right by delta.

### Repeat and Accumulate

One iteration of step 4 determines a single bit of the watermark. Step 4 must be repeated for each bit of the watermark to accumulate a complete value.

### Detect Redundant Information

The watermark may have been embedded into the document multiple times. If so, it can be read back multiple times to ensure consistency and integrity of the returned watermark. Doing this involves repeating the entire process multiple times. The same key can continue to be used to generate the locations of more information carrying lines.

Repeating the entire watermark is one useful way of gaining redundancy of the watermark information, but there are others. For example, one could add redundancy to the data, and resiliency in its detection, by adding error-correcting codes. There are many such codes and many coding schemes that are applicable to this invention. Using a scheme such as this entails adding additional bits to the watermark data to act as error correcting codes. These codes allow one to recover the correct watermark data even in the face of some number of bit errors while reading it. Such errors might be caused by severe smudges to the hardcopy or other modifications (like a human crossing out a sentence).

The Reed Solomon error-correcting code system would be a reasonable choice for this application. It deals well with localized errors that could be common in such an application. For example, a smudge that spread over several lines.

Though this above example focuses on the ability to detect a watermark in a hardcopy version of a document, detection can also take place in the electronic version. While the overall flow of processing is the same, the details are much simpler. No image processing is required and no correlation must be performed. Instead, one simply compares the left margin of a given line in Mₑ to the margin of the corresponding line in Oₑ. Determining the shift is just a matter of comparing the two numbers. Use of the key is the same as it is in the hardcopy detection case. It determines which lines on which pages carry the watermark information and the correspondence between a given line and the bit it represents in the watermark. Control lines are ignored in this case. They are only used for calibration purposes in the hardcopy case.

A variant on this approach allows detection without the need for the original document. In this case the control lines would be used as markers for the left margin of the shifted lines. The embedding code finds lines whose left margins are aligned and designates one as a control line. It would then shift the others to the left or right to encode the watermark information. The detector would locate the control lines and compare the margins of the shifted lines to the margins of the control lines. From this the detector can determine whether the lines have been shifted to the right or left. Selection of the control lines must be done carefully. For example, if the first line of a paragraph is indented while the rest are left justified, then the first line is not suitable as a control line because its left margin does not align with the margins of the following lines.

The following are alternative aspects that may or may not be used in conjunction with this invention:

1. Concentrate Lines. In the general algorithm each line that carries a bit of watermarking information could be on a different page. In practice it is much more efficient to use many or all of the available lines on a selected page to carry watermark information. This results in less pages having to be processed at both embedding time and detection time.

2. Collect processing steps. In the general algorithm several steps are performed repeatedly. This is not necessary. For example, rather than process a given page multiple times, once for each bit of the watermark that it contains, one could process the page once and pull out all of the bits that it contains. These bits would be combined with the bits found on other pages to form an overall watermark. For example, page 3 might contain bits 3, 8, 11, and 15 of the watermark. Page 3 only needs to be loaded and processed one time rather than 4 times.

3. Avoid scanning the original. It may be possible to avoid scanning the original document in order to generate the function h(x). This could be achieved by rasterizing the electronic form into a bitmap and then treating that bitmap as if it were a scanned image of the document.

4. Correlate over a subrange of h and g. Rather than performing the correlation of h and g over the full range of values of x (i.e. over the entire width of the scanline) correlate over a subrange of the line. Good results can be obtained with 300 dpi scans when correlating over a 400 pixel range that begins slightly before the first black pixels in a given line of text. That is, ignore leading white space and then correlate the waveforms of h and g over about the first 1 ⅓ inches.

5. Improve correctness using source analysis. For example, using source media analysis to aid in watermark detection in a dissimilar target media can be used to improve the correctness of not only this watermarking technique, but many others as well.

6. Confuse attackers with random variations. Lines that are not being used as control lines or to carry watermark information can be shifted at random. This will not confuse the detection process since it examines only the lines that are actually used. It will serve to further confuse an attacker as to which lines carry watermark information.

There are a number of obvious variations to this invention that could be applied to improve detection quality if necessary. For example, increasing the delta value, encoding a single bit with more than one line, and using error-correcting codes such as Reed Solomon. Detection without the original is typically less reliable than the detection with the original. There may be circumstances where this is a reasonable tradeoff since it removes the burden of having to maintain (a potentially very large set of) originals.

One conventional technique for watermarking textual documents is by substituting words, phrases, entire sentences, or punctuation. The present invention does not require any such manipulations, therefore it is not vulnerable to accidental changes to the meaning of a document.

Another conventional method shifts line spacing or the spacing between words. Because margin shifts are independent of line spacing and word spacing, this invention can be used in conjunction with other techniques if desired. That is, this watermarking algorithm can be used at the same time and in the same document as the line spacing algorithm of conventional methods to achieve even higher bandwidth (i.e. bits of information per page). In addition, the present invention requires fewer control lines and therefore can encode more bits of data in a given number of lines.

Other techniques embed a watermark in the electronic version of a document in a way that is not detectable in the visual representation of the document. This invention differs since it can detect the watermark in the hardcopy version of the document as well as from the electronic version.

Although the invention has been described relative to a particular embodiment, one of skill in the art will appreciate that this description is merely exemplary and the system and method of this invention may include additional or different components, while operating within the scope of the invention.

What is claimed is:

1. A method for detecting a watermark in a document, comprising:
loading a page image of a watermarked document;
locating a set of scanlines in the watermarked page image;
calculating a detection value;
loading a page image of an original document;
locating a set of scanlines in the original page image;
calculating a target value; and
determining a difference between the target value and the detection value.

2. The method according to claim 1 wherein the step of determining a difference includes determining the amount of left margin shift based on the difference between the target value and the detection value.

3. The method according to claim 2 wherein the step of determining the amount of left margin shift includes determining the direction of left margin shift based on the difference between the target value and the detection value.

4. A method for watermarking a document, comprising:
determining a watermark value;
determining a watermark key;
determining a watermark line based on the watermark key; and
shifting a left margin of the watermark line based on the watermark value.

5. A computer-readable medium having stored thereon a plurality of sequences of instructions for watermarking a document, the plurality of sequences of instructions including sequences of instructions, which, when executed by a processor, cause the processor to perform the steps of:
determining a watermark value;
determining a watermark key;
determining a watermark line based on the watermark key; and
shifting a left margin of the watermark line based on the watermark value.
